(19) United States
(12) Patent Application Publication
(10) Pub. No.: US 2014/0188581 A1
(43) Pub. Date: Jul. 3, 2014

(54) WIRELESS MARKETING

(71) Applicant: Christopher Hutchison, Columbus, OH (US)

(72) Inventor: Christopher Hutchison, Columbus, OH (US)

(21) Appl. No.: 13/781,643

(22) Filed: Feb. 28, 2013

Related U.S. Application Data
(60) Provisional application No. 61/747,981, filed on Dec. 31, 2012.

(51) Int. Cl. G06Q 30/02

(52) U.S. Cl. CPC G06Q 30/0252
USPC 705/14.5

(57) ABSTRACT

A system, method, and network through which a Wi-Fi hot spot provider provides Internet access to users in exchange for the right to send marketing messages to the user from vendors. The Wi-Fi hot spot provider charges vendors for delivering marketing messages and ensures that access is limited to user-agreed parameters. The system, method, and network uses cellular telephone text messaging in a way that integrates location based advertising and text based advertising. The system, method, and network creates opportunities for up-sell by delivering marketing messages and offers to users who actually visited the particular venue and may still be present in the venue; tracking the user's participation and response to marketing messages in order to direct further marketing after the user has left the venue; and having knowledge of past marketing messages when the user re-appears at an event or at a similar event.

### CROSS-REFERENCE TO RELATED APPLICATIONS

This application is related to a Provisional Application No. 61/747,981, filed Dec. 31, 2012, entitled “WIRELESS MARKETING,” attorney docket 20121231.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present disclosure relates to the technical field of marketing, and more specifically with presenting marketing information to cellular telephone users who desire Wi-Fi access while attending an event.

### SUMMARY OF THE INVENTION

Wi-Fi hot spot providers often offer free Wi-Fi internet access services as a loss leader to attract customers onto the premises. Providers do so at significant cost, and hope that the customers will buy additional products or services during their visit or perhaps later. Coffee shops, restaurants, and hotels are examples. Wi-Fi services are also offered at events, such as concerts, sports events, conventions, and other places where people are gathered in a relatively contained geographical area and where one or more of them may desire internet access during attendance or visit.

Coupled with this is the wide-spread use of cellular telephones, through which customers may also access the internet through a cellular telephone provider. However, increasingly, despite marketing and advertising that suggests that such access is “unlimited” for customers who pay a fixed fee, cellular telephone providers are both increasing costs based on monthly data transfer quotas and, at times, limiting access by reducing data transfer capacity if the customer exceeds certain usage limits.

Access to Wi-Fi can alleviate the customer's additional charges from cellular telephone providers by directing Internet activity to take place through Wi-Fi instead of through the cellular telephone network. Many cellular telephone users first seek Wi-Fi Internet access before seeking access through the cellular telephone network.

The Wi-Fi hot spot provider at an event may charge a small fee to recover costs of or profit from providing the service. The Wi-Fi hot spot provider may, instead, offer the services without charge, and hope that costs will be recovered through indirect means. Current implementations for providing Wi-Fi hot spot access services are not effective in allowing the Wi-Fi hot spot provider to recover costs without charging for usage because they are passive. Further, providers do not generally have a means of identifying the users for later contact.

We disclose a systems and method through which a Wi-Fi hot spot provider may provide Internet access to customers in exchange for the right to send directed and limited marketing messages to the customer from vendors. The Wi-Fi hot spot provider charges vendors for delivering marketing messages and ensures that access is limited to customer-agreed parameters. This disclosure reveals a Wi-Fi hot spot access granting and authentication system and method that uses cellular telephone text messaging in a way that integrates location based advertising and text based advertising. The system and method creates opportunities for up-sell by a) delivering marketing messages and offers to customers who actually visited the particular venue and may still be present in the venue; b) tracking the customer's participation and response to the marketing messages in order to direct further marketing after the customer has left the venue; and c) having knowledge of past marketing messages when the customer re-appears at an event or at a similar event.

A typical sequence includes, but is not limited to, the following:
1. The user seeks Internet access through the Wi-Fi hot spot provider, by first initiating a Wi-Fi hot spot request for access session. The user is offered a choice: accept a limited number of marketing messages to be delivered via cellular telephone text messages in exchange for free Internet access, or pay a fee for Internet access. The choice for free access may also include an option to select from a number of vendors from which vendor messages will be accepted.
2. If the user chooses to pay a fee, then Wi-Fi Internet access is granted. The user gets back a unique password that allows access to the Internet via the Wi-Fi hot spot. The password, and access, is good for a specific time period, and thus the user is granted access to the Wi-Fi service during that period. No marketing information is provided. The Wi-Fi hot spot provider may thus recoup some costs via the fee.
3. However, if the user chooses free access, then the Wi-Fi hot spot service provider system prompts for a cellular telephone number as a pre-condition to access to Internet via Wi-Fi, and to offer other choice options. The user is also promised that the marketing message delivery via text messaging is limited to the particular times, places, and manners indicated.
4. The user seeking Internet access indicates agreement by responding with a cellular telephone number.
5. Via simple SMS text message sent to the cellular telephone number provided by the user, or messages sent through the Wi-Fi hot spot request for access session, the user gets back a unique password that allows access to the Internet via the Wi-Fi hot spot. The password, and access, is good for a specific time period, and thus the user is granted access to the Wi-Fi service during that period. The unique password is associated with the particular cellular telephone number.
6. The text message may also include a digital coupon or marketing or advertising message. Coupons and offers will have a code that is associated with the cellular telephone number. Redemption of the coupon or offer requires disclosing the code.
7. If the user redeems the coupon, redemption will be associated with the cellular telephone number.
8. Over time, each use will be associated with the cellular telephone number and logged. Thus patterns of usage may be derived.
9. The cellular telephone number and marketing information is retained by the Wi-Fi hot spot provider after the Internet access session is over.
10. The patterns of usage data may be examined for marketing purposes; in order to present the particular user with targeted marketing in the future.
11. The method and system may decide appropriate times to send or not send marketing messages via text messaging.
12. The Wi-Fi hot spot provider manages all message transfers from vendor to user, and does not reveal the user's identification or cellular telephone number. Agreements between the Wi-Fi hot spot provider and vendors may manage access to customer information after initial contact.

### BRIEF DESCRIPTION OF THE DRAWINGS

FIG. 1 shows a general topology and relationships among users, vendors, the system, the cellular telephone network, and the Internet.

FIG. 2 shows a model of the system in Unified Modeling Language (“UML”) sequence diagram syntax and particularly showing system administrator access transactions.

FIG. 3 shows a UML model of the system particularly showing vendor access transactions.

FIG. 4 shows a UML model of the system particularly showing user access transactions, including accepting terms, logging in, and logging out. The request here is made through SMS text message, but may alternatively be made through the Wi-Fi hot spot request for access session.

FIG. 5 shows a UML model of the system particularly showing marketing messages being sent to the user while the Internet session is still active.

FIG. 6 shows a UML model of the system particularly showing marketing messages being sent to the user after the Internet session is terminated.

Reference Numerals

| | |
|---|---|
| 100 | Server |
| 110 | User |
| 112 | Cellular telephone |
| 114 | Computer |
| 120 | Administrator |
| 130 | Vendor |
| 150 | Internet |
| 152 | SMS Gateway |
| 200 | Model |
| 202 | Activity monitor sequence stream |
| 206 | Administrative interface sequence stream |
| 210 | Vendor interface sequence stream |
| 212 | Login sequence stream |
| 214 | Administrator sequence stream |
| 216 | Access device sequence stream |
| 217 | Cellular telephone sequence stream |
| 218 | SMS gateway sequence stream |
| 220 | Vendor sequence stream |
| 250 | Enable login message |
| 252 | Configuration message |
| 254 | Provision message |
| 256 | Request for information |
| 258 | Information |
| 262 | Registration message |
| 268 | Request to send marketing message |
| 270 | Acknowledgment |
| 272 | Request for Internet access |
| 274 | Internet access information |
| 276 | Internet access information |
| 278 | Internet access information to computer |
| 280 | Login request |
| 282 | Logout request |
| 290 | Marketing message |
| 298 | Acknowledgment |

### DETAILED DESCRIPTION OF THE INVENTION

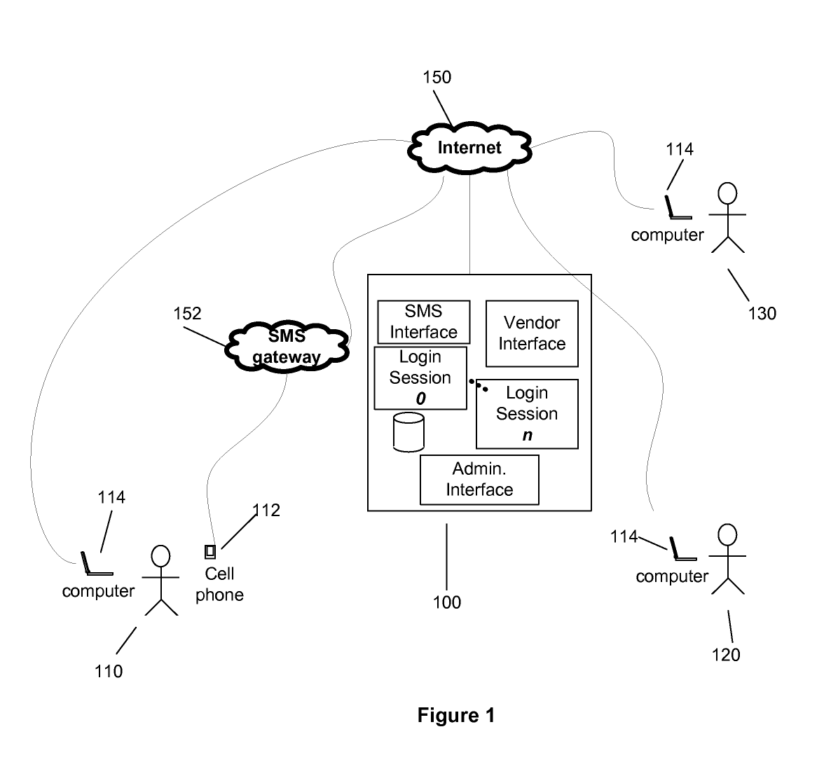

FIG. 1 shows a general topology and relationships among users 110, vendors 130, the server 100, the cellular telephone SMS gateway 152, and the Internet 150. Central component is a server 100, with an SMS (“short message service, a.k.a. text messaging service”) interface, a vendor interface, an administrative interface, a database, and processing capability to provide one or more login sessions. The server 100 uses two network gateways: an Internet 150 for transactions occurring over the internet 150, and the SMS gateway 152 for sending and receiving messages over the cellular SMS network. Access to the SMS gateway 152 is typically via the Internet 150 but may be accomplished through a land-based switched telephone network. The user 130 who wants Wi-Fi access to the Internet 150 has a cellular telephone 112 capable of receiving text messages and may also have Wi-Fi access capability. If the cellular telephone 112 is not capable of Wi-Fi access, then the user may have an access device 114 that has such access. An administrator 120 accesses the server 100 via the administrator interface, and may do so over the internet 150 or over an internal network. The administrator 120 configures and manages the server 100 through the administrator access interface. One or more vendors 130, where FIG. 1 depicts one such vendor 130, configure and manage certain vendor aspects of the system through the vendor interface. Vendor 130 access to the server 100 via the vendor interface may take place over the Internet 150 or over an internal network.

The server 100 may be owned by one or more proprietors who derive income from operation of the server 100.

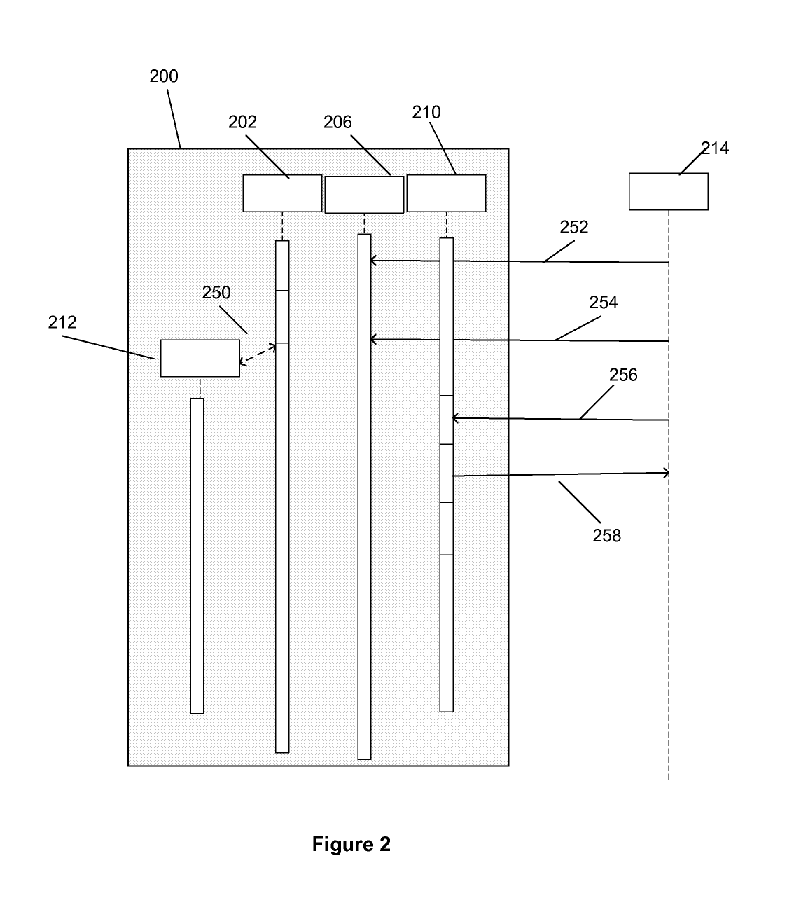

FIG. 2 shows a model 200 of the server 100 in Unified Modeling Language (“UML”) sequence diagram syntax and particularly showing administrator 120 access transactions. Four sequence streams are shown: a vendor interface sequence stream 210 which corresponds to the vendor interface, an administrative interface sequence stream 206 which corresponds to the administrator interface, an activity monitor sequence stream 202 that corresponds to operations that monitor and mange all aspects of the server 100, and a login sequence stream 212 that corresponds to a login session with a current or prospective user 110. Each such stream represents running processes inside the server 100. The administrator 120, as represented by an administrator sequence stream 214, sends configuration messages 252 and provisioning messages 254 to the administrator interface sequence stream 206. The administrator 120 also sends requests for information messages 256 to the vendor interface sequence stream 210 and receives requested information 258 from the vendor interface sequence stream 210.

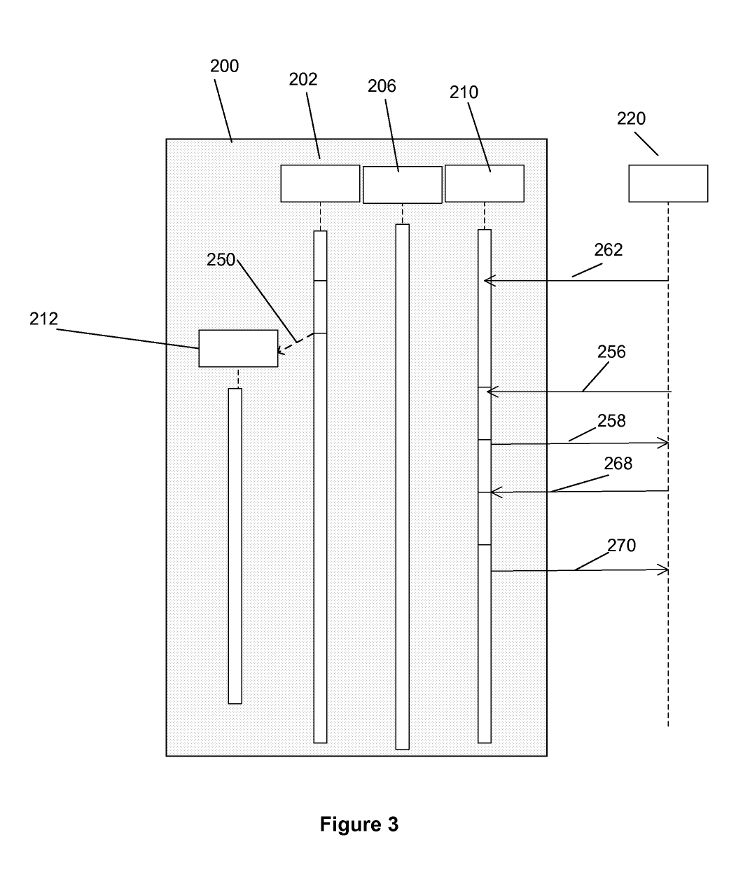

FIG. 3 shows the UML model 200 of the server 100 particularly showing vendor 130 access transactions. The vendor 130, acting through a vendor sequence stream 220 in the UML model 100, sends a registration message 262 to the vendor interface sequence stream 210, through which the vendor 130 adds marking messages and other information. Also, the vendor 130 may send a request for information 256 message to the vendor interface sequence stream 210, seeking information about user activity. The vendor interface sequence stream 210 would reply with responsive information 258. Although delivery of marketing messages may be pre-determined according to agreement between the vendor 130 and the administrator 120, the vendor 130, via the vendor sequence stream 220 and to the vendor interface sequence stream 210, may send an ad hoc request to send a marketing message 268 to the user 110. If the agreement between vendor 130 and administrator 120 allows and if the server 100 is configured to honor the agreement, then the vendor interface sequence stream 210 would send an acknowledge 270 message to the vendor sequence stream 220 and the administrator sequence interface stream 206 would execute the request.

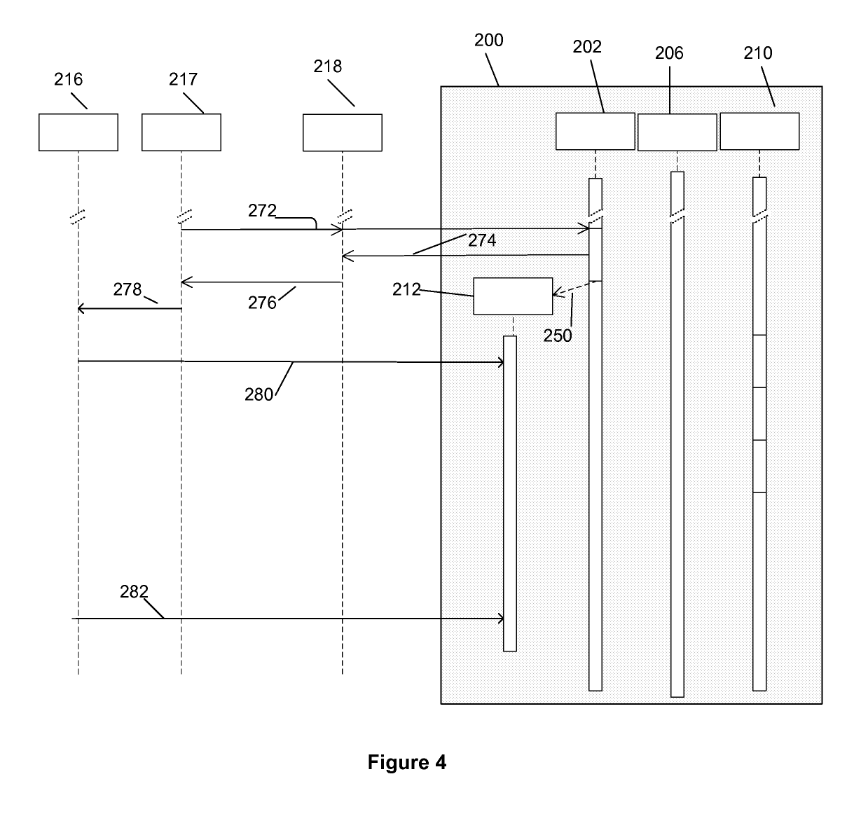

FIG. 4 shows the UML model 200 of the server 100 particularly showing user 110 access transactions, including accepting terms, logging in, and logging out. FIG. 4 depicts three additional sequence streams for the UML model. In order to obtain information needed to gain access to the Internet 150, the user 110 must make a request for Internet access 272. To do so, the user 110 selects and then acts through one of two streams: a cellular telephone sequence stream 217 and a computer sequence stream 218. As previously stated, the cellular telephone 112 may have both SMS capability as well as Internet access capability. We depict this as two streams: the cellular telephone sequence stream 217 and the access device sequence stream 216, although the single cellular telephone 112 may be used alone or with access device 114. An SMS gateway sequence stream 218 depicts text message flows between the server 100, via SMS gateway 152, and the cellular telephone 112 SMS which would be readable by the user 110. The request for Internet access 272 as shown in FIG. 4 is made through an SMS text message, but may alternatively be made through the Wi-Fi hot spot request for access session from the access device 114. In the depicted mode, the user 110, through its cellular telephone sequence stream 217 sends a request for Internet access 272 through and SMS gateway sequence stream 218 to the server 100, as represented in the model 200 and the activity monitor sequence stream 202. Some choice offerings are presented to the user 110: pay for Internet access, or have free access in exchange for accepting marketing messages. If the user 110 accepts the choice of free Internet access in exchange for accepting marketing text messages, the server 100, as shown in the model 200, sends Internet access information 274 via the activity monitor sequence stream 202 to the user 110 through the SMS gateway sequence stream 218. Thus, an enable log in message 250 enables an Internet login sequence stream 212 for the user 110. The SMS gateway sequence stream 218 receives the Internet access information 274 from the activity monitor sequence stream 202, and then sends the information 276 to the user 110 cellular telephone 112, as depicted by the cellular telephone sequence stream 217. Marketing information is contained in information 274 and information 276. The user 110 may then use the information 276 to access the login sequence stream 212 and thus be connected to the Internet 150. When the user 110 is finished, the user may log out via a logout request 282 delivered from user 110 access device sequence stream 216 to the login sequence stream 212.

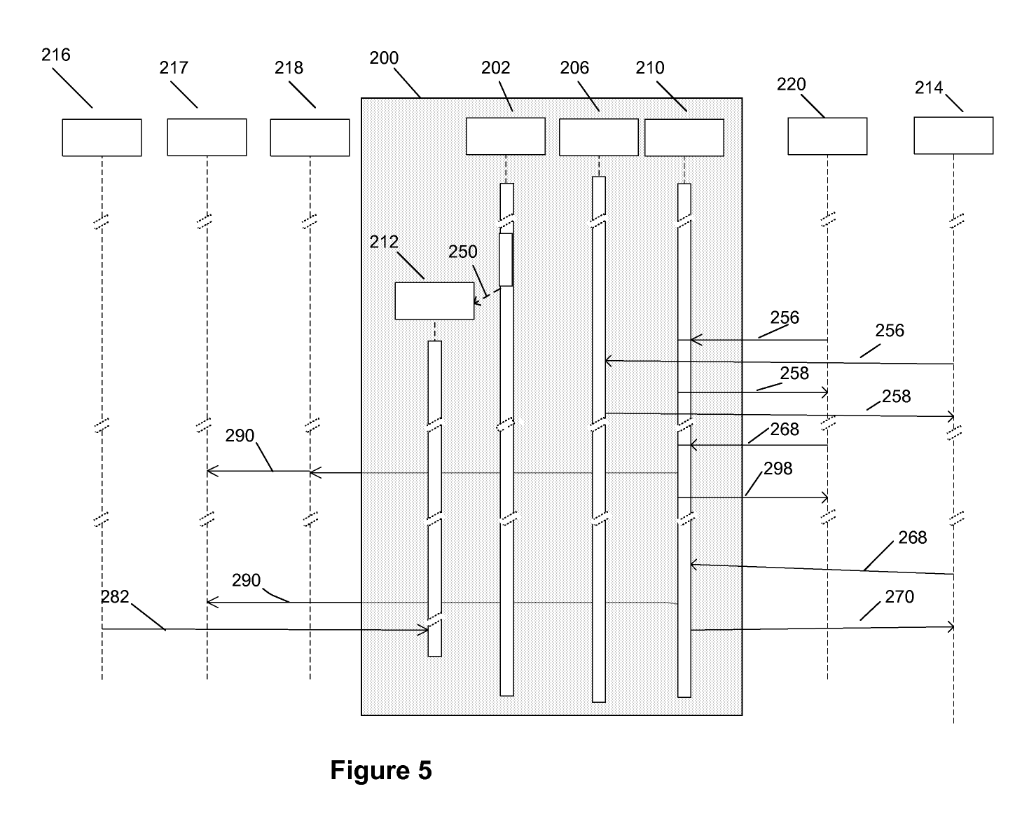

FIG. 5 shows UML model 200 of the server 100 particularly showing requests to send marketing messages 268 being sent to the user 110 while the login sequence stream 212, and thus access to the Internet 150, is still active. In FIG. 5 the user 110 is still logged in. Although delivery of marketing messages may be pre-determined according to agreement between the vendor 130 and the administrator 120, the vendor 130, via the vendor sequence stream 220 and to the vendor interface sequence stream 210, may send an ad hoc request to send a marketing message 268 to the user 110. If the agreement between vendor 130 and administrator 120 allows and if the server 100 is configured to honor the agreement, then the vendor interface sequence stream 210 would send an acknowledge 270 message to the vendor sequence stream 220 and the administrator sequence interface stream 206 would execute the request.

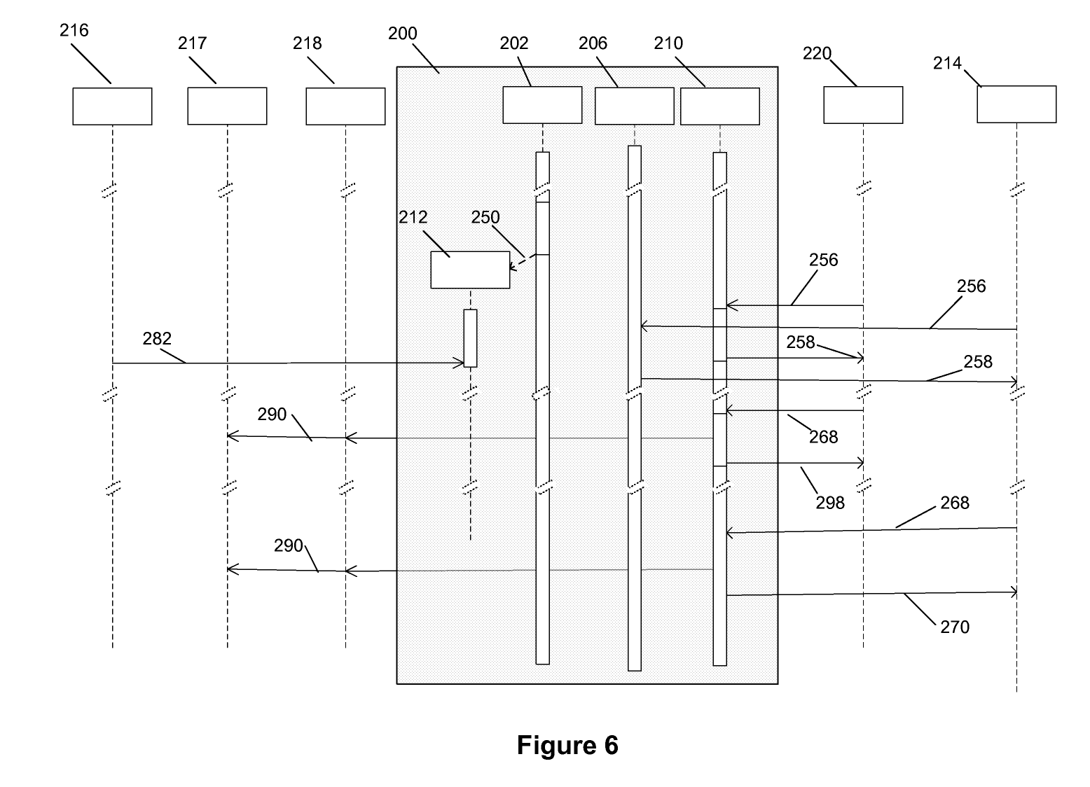

FIG. 6 shows a UML model of the system particularly showing marketing messages being sent to the user after the Internet session are terminated. In FIG. 6, the user has logged out, and yet may still be due marketing messages. Such unsent marketing messages are sent via SMS message. Although delivery of marketing messages may be pre-determined according to agreement between the vendor 130 and the administrator 120, the vendor 130, via the vendor sequence stream 220 and to the vendor interface sequence stream 210, may send an ad hoc request to send a marketing message 268 to the user 110. If the agreement between vendor 130 and administrator 120 allows and if the server 100 is configured to honor the agreement, then the vendor interface sequence stream 210 would send an acknowledge 270 message to the vendor sequence stream 220 and the administrator sequence interface stream 206 would execute the request.

Each marketing message incurs a charge to be paid by the vendor 130 to the proprietors of the system.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. For example, the user may be presented with only two choices: allow marketing messages or have no access. The user may perhaps indicate that it will accept messages only from a list of vendors, such list being presented by the system. Furthermore, messages may be delivered via the Internet while the user is logged in, or perhaps via e-mail, instead of or in conjunction with SMS text messages. In all cases, care is taken, and expressed in rules, that the customer is not offended by content or volume of messages, and that the entire delivery and solicitation complies with applicable law. The invention should therefore not be limited by the above described embodiment, method, and examples, but by all embodiments and methods within the scope and spirit of the invention.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

I claim:

1. A system for wireless marketing by which marketing messages and access messages are sent to a plurality of users, the system comprising:
a server, having an administrative interface, vendor interface, a plurality of login sessions, where each such login session may be allocated among the plurality of users;
the server further having the marketing messages and the access messages to be delivered to the plurality of users;
the marketing messages further comprising information about vendor products and services;
the access messages further comprising information that enables access for each of the plurality of users to one of the plurality of login sessions, respectively;
the server further having a Wi-Fi hot spot through which each of the plurality of users with access information may have access to an internet;
each of the plurality of users having an access device for connection to the network;
a cellular telephone operated by each one of the plurality of users, where the each such cellular telephone is capable of sending and receiving marketing and access messages via an SMS gateway, wherein the SMS gateway sends and receives the marketing messages and access messages to the respective cellular telephone of each such plurality of users, respectively;
each such cellular telephone further having a telephone number, respectively;
wherein the system provides Internet access to each of the plurality of users, respectively, who agree to receive marketing messages;
the server may retain the cellular telephone number and a transaction history for the plurality of users;
and,
the server having rules by which the system may select appropriate times to send or not send the marketing messages.

2. A method for wireless marketing by which marketing messages and access messages are sent to a plurality of users, the method comprising:
each one of the plurality of users who seeks access to an internet requests access from a server by way of a Wi-Fi hot spot;
the server responds by way of with an offer for the respective one of the plurality of users to accept marketing messages in exchange for being allowed access to the internet;
for each one of the plurality of users, respectively, accepts the offer, the respective user sends a cellular telephone number to the server, for the respective user to receive one or more SMS text messages;
the server sends access information to the respective user via the one or more SMS text message to the respective user;
the user receives the access information and uses it to obtain access to the internet through the Wi-Fi hot spot;
the server sends marketing information to the respective user via the one or more SMS text messages;
the server may retain a transaction history;
and,
the server may select appropriate times to send or not send the marketing messages according to rules.

3. A network for wireless marketing by which marketing messages and access messages are sent to a plurality of users, the network comprising:
a plurality of vendors seeking to send marketing messages to users;
a server for providing access to an internet in exchange for permission to send marketing an SMS gateway for communication among the plurality of users, the plurality of vendors, an administrator, and the server;
said administrator having access to the server by the internet or directly;
an internet configured for communication among the plurality of users, the plurality of vendors, the administrator, and the server;
a plurality of users seeking access to the internet, each such user having a cellular telephone capable of sending and receiving SMS messages and each such user having a device capable of internet access;
wherein the network allows each of the plurality of users access to the internet, where each such user is allowed access, respectively, in exchange for accepting marketing messages.
